(19) United States
(12) Patent Application Publication
(10) Pub. No.: US 2026/0202780 A1
(43) Pub. Date: Jul. 16, 2026

(54) IMAGE FORMING APPARATUS THAT FIXES TONER IMAGE BY THERMAL COMPRESSION

(71) Applicant: KYOCERA Document Solutions Inc., Osaka (JP)

(72) Inventor: Shunsaku FUJII, Osaka (JP)

(73) Assignee: KYOCERA Document Solutions Inc., Osaka (JP)

(21) Appl. No.: 19/440,536

(22) Filed: Jan. 5, 2026

(30) Foreign Application Priority Data
Jan. 10, 2025 (JP) 2025-004185

(51) Int. Cl. G03G 15/20

(52) U.S. Cl. CPC G03G 15/2046; G03G 15/2053; G03G 15/2064; G03G 2215/2035

(57) ABSTRACT

A first temperature sensor detects a first temperature of a region in a heating device. A second temperature sensor detects a second temperature of a portion of the heating device between one end, and an end of the region on the side of the one end. A sheet sensor detects a medium passing a position in a nip region corresponding to a portion of the heating device between the other end, and the other end of the region on the side of the other end of the heating device. A controller starts successive transport of the medium at a first number. Upon deciding that a temperature difference is smaller than a first threshold, and that the medium has not been detected, the controller changes the number of sheets of the successive transport to a second number, fewer than the first number.

### INCORPORATION BY REFERENCE

This application claims priority to Japanese Patent Application No. 2025-004185 filed on January 10, 2025, the entire contents of which are incorporated by reference herein.

### BACKGROUND

The present disclosure relates to an image forming apparatus including a fixing device that fixes, by thermal compression, a toner image formed on a recording medium.

Existing electrophotographic image forming apparatuses include a fixing device that fixes a toner image transferred to a recording medium. In general, the fixing device includes a heat roller extending in an orthogonal direction, orthogonal to the direction in which a recording medium is transported by a transport device, a pressure roller extending in the orthogonal direction opposite the heat roller, and defining, in collaboration with the heat roller, a nip region through which the recording medium to undergo the fixing process is to pass, and a heating device that heats the heat roller. The heating device is located inside the heat roller so as to extend in the orthogonal direction from an end portion of the heat roller to the other end portion thereof. At the nip region, the toner image is heated and pressed (thermal compression), thus to be fixed onto the recording medium.

In the image forming apparatus including such a fixing device, for example, when successive printing is performed on a small-sized recording medium at the same printing interval as for a large-sized recording medium, the temperature of a region on the heat roller where the recording medium does not pass (non-passage region) excessively rises. When printing is performed on the large-sized recording medium, with the non-passage region excessively heated, the toner on the portion of the large-sized recording medium, corresponding to the non-passage region of the small-sized recording medium, excessively melts.

Accordingly, a throughput-down (TPD) control is performed, including lowering the productivity (number of sheets to print per unit time, specified with respect to each sheet type used) of the image forming operation, for example by extending the interval between the sheets. By performing the TPD control, for example when the temperature at the end of the heat roller reaches a certain threshold, the number of sheets transported per unit time is reduced, and therefore the power supply to the heating device per unit time is reduced. As result, the excessive increase in temperature in the non-passage region of the heating roller can be prevented.

For example, the fixing device includes three temperature sensors that each detect the temperature of the heat roller, aligned in the orthogonal direction orthogonal to the direction in which the recording medium is transported toward the nip region. The temperature sensor at the center detects the temperature of the portion of the heating device corresponding to the region on the heat roller where the recording medium of all the sizes passes. The temperature sensors at the respective end portions detect the temperature of the portion of the heating device corresponding to the region on the heat roller where the large-sized recording medium passes, but the small-sized recording medium does not pass. Thus, the temperature is managed at three positions on the heating device. The power is supplied to the heating device, such that the temperature detected by the central temperature sensor is maintained at a predetermined fixing temperature. When the temperature detected by the temperature sensors at the respective end portions reaches a throughput-down temperature, the pages per minute (PPM) is reduced, and when thereafter the detected temperature falls below the throughput-down temperature, the PPM is increased, in proportion to the drop of the temperature per predetermined time.

### SUMMARY

The disclosure proposes further improvement of the foregoing technique.

In an aspect, the disclosure provides an image forming apparatus including a fixing device, a control device including a processor, and configured to act as a controller, when the processor executes a control program, and a transport device. The transport device transports a recording medium to the fixing device. The fixing device includes a heat roller, a pressure roller, and a heating device. The heat roller extends in an orthogonal direction, orthogonal to a direction in which the transport device transports the recording medium. The pressure roller extends in the orthogonal direction opposite the heat roller, and defines, in collaboration with the heat roller, a nip region through which the recording medium to undergo a fixing process is to pass. The heating device is located inside the heat roller so as to extend in the orthogonal direction from an end portion of the heat roller to the other end portion thereof, and heats the heat roller. The transport device transports the recording medium of a predetermined minimum size, through a predetermined region of the heat roller and the pressure roller, including a central portion of the heat roller and the pressure roller in the orthogonal direction. The fixing device further includes a first temperature sensor, a second temperature sensor, and a sheet sensor. The first temperature sensor detects, as a first temperature, a temperature of the predetermined region in the heating device. The second temperature sensor detects, as a second temperature, a temperature of a portion of the heating device between one end portion thereof in the orthogonal direction, and an end portion of the predetermined region on a side of the one end portion of the heating device. The sheet sensor is located at a position in the nip region corresponding to a portion of the heating device between the other end portion thereof in the orthogonal direction, and the other end portion of the predetermined region on a side of the other end portion of the heating device, and detects presence of the recording medium passing through the nip region. The controller controls power supply to the heating device, to set the first temperature to a prespecified fixing temperature. The controller starts successive transport of the recording medium to the nip region by the transport device, at a predetermined first number of sheets per predetermined time. Upon deciding that a temperature difference between the first temperature and the second temperature is smaller than a predetermined first threshold of the temperature difference, and that the sheet sensor has not detected the recording medium, the controller changes the number of sheets per predetermined time, of the successive transport of the recording medium to the nip region by the transport device, from the first number of sheets to a predetermined second number of sheets, fewer than the first number of sheets.

### BRIEF DESCRIPTION OF THE DRAWINGS

FIG. 1 is a cross-sectional view showing a configuration of an image forming apparatus, according to an embodiment representing an aspect of the disclosure;

FIG. 2 is a functional block diagram showing an electrical configuration of the image forming apparatus shown in FIG. 1;

FIG. 3 is a cross-sectional view showing a configuration of the fixing device shown in FIG. 1;

FIG. 4 is a schematic drawing showing locations of a first temperature sensor, a second temperature sensor, and a sheet sensor included in the fixing device shown in FIG. 3;

FIG. 5 is another schematic drawing showing locations of the first temperature sensor, the second temperature sensor, and the sheet sensor included in the fixing device shown in FIG. 3;

FIG. 6 is a flowchart showing a productivity control process, performed by the controller shown in FIG. 2; and

FIG. 7 is a flowchart showing the productivity control process subsequent to the process of FIG. 6, performed by the controller shown in FIG. 2.

### DETAILED DESCRIPTION

Hereafter, an image forming apparatus according to an embodiment, representing an aspect of the disclosure, will be described with reference to the drawings.

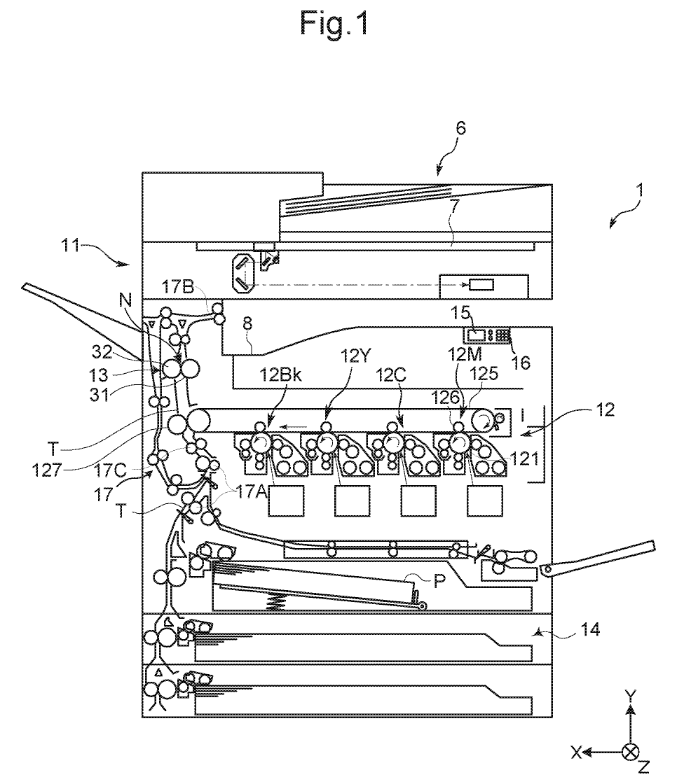

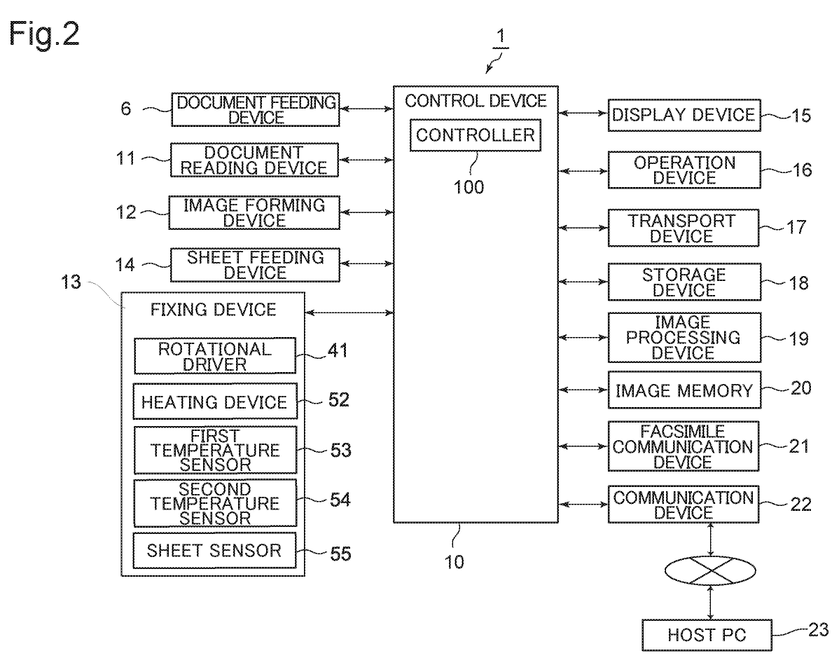

FIG. 1 is a cross-sectional view showing a configuration of the image forming apparatus 1, according to the embodiment representing an aspect of the disclosure. FIG. 2 is a functional block diagram showing an electrical configuration of the image forming apparatus 1 shown in FIG. 1. The image forming apparatus 1 is a multifunction peripheral having a plurality of functions, such as copying, transmitting, printing, and facsimile transmission.

The image forming apparatus 1 includes, as shown in FIG. 1, a document feeding device 6, a document reading device 11, an image forming device 12, a fixing device 13, a sheet feeding device 14, a display device 15, an operation device 16, and a transport device 17.

The document feeding device 6 delivers documents placed on a document tray one by one to a reading position of the document reading device 11. The document feeding device 6 is configured to open and close a platen glass 7, by being made to pivot up and downward about a shaft located on the deeper side in FIG. 1. The document feeding device 6 also serves as a document retention cover that presses the document on the platen glass 7 from the upper side.

The document reading device 11 includes a scanner that optically reads the document, and generates the image data representing the document image. The document reading device 11 reads the document delivered from the document feeding device 6, or the document placed on the platen glass 7.

The image forming device 12 includes a photoconductor drum, a charging device, an exposure device, a developing device, and a transfer device. The exposure device includes a laser scanning unit (LSU). The image forming device 12 forms a toner image on a sheet P transported along a transport route T by the transport device 17, on the basis of the image data. In the case of color printing, an image forming unit 12M for magenta, an image forming unit 12C for cyan, an image forming unit 12Y for yellow, and an image forming unit 12Bk for black, included in the image forming device 12, form the toner image of magenta, cyan, yellow, and black, respectively, on a photoconductor drum 121 through charging, exposing, and developing processes. The toner images of the respective colors formed as above are transferred and overlaid on each other on an intermediate transfer belt 125 via a primary transfer roller 126, thus to be formed into a colored toner image. Such colored toner image is transferred via a secondary transfer roller 127 to the sheet P, transported along the transport route T. In the case of monochrome printing, the image forming unit 12Bk for black in the image forming device 12 forms a black toner image on the photoconductor drum 121, through the charging, exposing, and developing processes. The black toner images formed as above is transferred to the intermediate transfer belt 125 via the primary transfer roller 126. The monochrome toner image transferred to intermediate transfer belt 125 is transferred, via the secondary transfer roller 127, to the sheet P transported along the transport route T.

The fixing device 13 heats and presses the sheet P on which the toner image has been formed, to thereby fix the toner image onto the sheet P. The sheet P on which the toner image has been fixed is delivered to an output tray 8.

The sheet feeding device 14 includes a manual bypass tray, a plurality of sheet cassettes, a pickup roller, and a sheet feeding motor. The sheet feeding device 14 draws out the sheets P stored in one of the plurality of sheet cassettes, or set on the manual bypass tray one by one, with the pickup roller driven to rotate by the sheet feeding motor, and delivers the sheet P to the transport route T. Here, the sheet P is not limited to a paper medium but may be, for example, an overhead projector (OHP) sheet. The sheet P and the OHP sheet exemplify the recording medium in the disclosure.

The display device 15 includes a liquid crystal display or an organic light-emitting diode display, and displays various types of screen. The operation device 16 includes a plurality of hard keys such as a start key, for inputting instructions to execute a copying operation or a scanning operation, and a touch panel overlaid on the display device 15. To the operation device 16, the instruction from the user is inputted.

The transport device 17, which serves to transport the sheet P to the image forming device 12 and the fixing device 13, includes transport roller pairs 17A, a delivery roller pair 17B, a resist roller 17C, and a transport motor. When the transport roller pair 17A, the delivery roller pair 17B, and the resist roller 17C are driven to rotate by the transport motor, the sheet P delivered from the sheet feeding device 14 is transported along the transport route T, to the image forming device 12 and the fixing device 13.

The image forming apparatus 1 further includes, as shown in FIG. 2, a control device 10, a storage device 18, an image processing device 19, an image memory 20, a facsimile communication device 21, and a communication device 22.

The control device 10 is electrically connected to the document feeding device 6, the document reading device 11, the image forming device 12, the fixing device 13, the sheet feeding device 14, the display device 15, the operation device 16, the transport device 17, the storage device 18, the image processing device 19, the image memory 20, the facsimile communication device 21, and the communication device 22.

The control device 10 controls the operation of each component of the image forming apparatus 1.

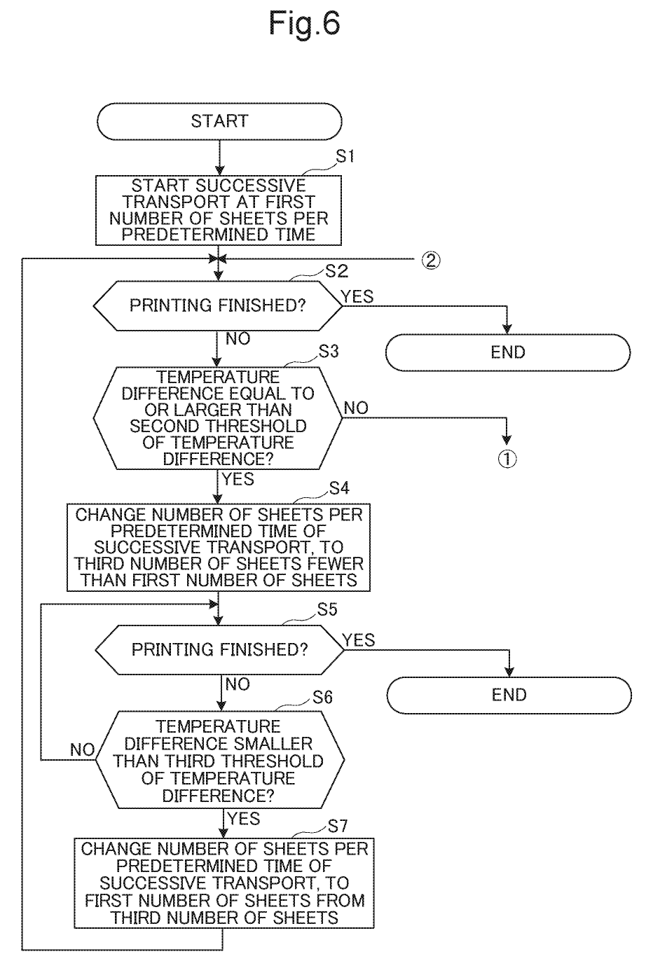

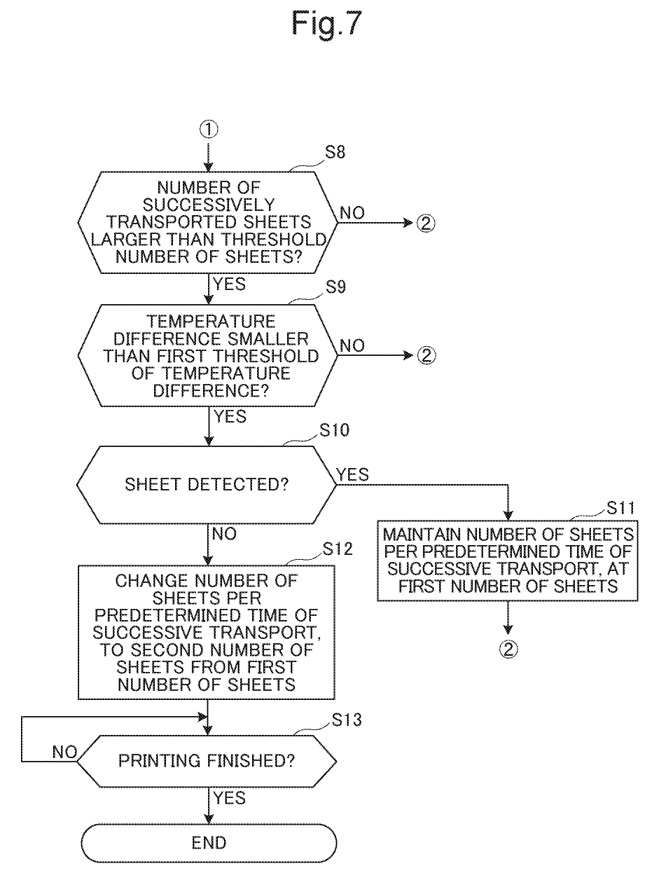

The storage device 18 is a large-capacity storage medium, such as a hard disk drive (HDD) or a solid state drive (SSD), for storing various types of data, and containing various computer programs including control programs for realizing the functions of the image forming apparatus 1. In this embodiment, a productivity control program, for the control device 10 to execute a productivity control process shown in FIG. 6 and FIG. 7, is installed in the storage device 18.

The image processing device 19 executes image processing (e.g., rasterization, color conversion, rotation/aggregation, resolution conversion, and screen processing) with respect to the image data. In the image memory 20, the image data is temporarily stored. The facsimile communication device 21 transmits and receives the image data, through the public telephone network. The communication device 22 includes a communication module such as a local area network (LAN) board. The control device 10 performs data communication via the communication device 22, with an external device such as a host personal computer (PC) 23 connected via a network.

The control device 10 includes a processor, a random-access memory (RAM), and a read-only memory (ROM). The processor is, for example, a central processing unit (CPU), a micro processing unit (MPU), or an application specific integrated circuit (ASIC).

The control device 10 acts as a controller 100 that controls the operation of the document feeding device 6, the document reading device 11, the image forming device 12, the fixing device 13, the sheet feeding device 14, the display device 15, the operation device 16, and the transport device 17, when the processor executes the control programs including the productivity control program, stored in the ROM or the storage device 18. Here, the controller 100 may be constituted in the form of a hardware circuit, instead of being realized by the operation of the control device 10 according to the control programs including the productivity control program. This also applies to other embodiments, unless otherwise specifically noted.

When the image forming apparatus 1 performs the document reading operation, the document reading device 11 optically reads, under the control of the controller 100, the image on the document delivered from the document feeding device 6, or placed on the platen glass 7, and generates image data. The image data generated by the document reading device 11 is stored, for example, in the image memory 20.

In the case where the image forming apparatus 1 performs the image forming operation, when the sheet feeding motor of the sheet feeding device 14 drives the pickup roller to rotate, under the control of the controller 100, the sheets P are drawn out one by one. When the controller 100 drives the transport motor of the transport device 17 so as to rotate the transport roller pair 17A, the delivery roller pair 17B, and the resist roller 17C, the sheet P drawn out by the sheet feeding device 14 is transported along the transport route T to the image forming device 12, and then to the fixing device 13 along the transport route T, and further transported along the transport route T to be delivered to the output tray 8. The image processing device 19 performs, under the control of the controller 100, the image processing operation with respect to the image data generated through the document reading operation and stored in the image memory 20, the image data stored in the storage device 18, or the image data received from a computer connected via the network. Then the image forming device 12 forms a toner image on the sheet P, transported along the transport route T toward the image forming device 12, on the basis of the image data that has undergone the image processing operation by the image processing device 19. The fixing device 13 heats and presses the sheet P, now having the toner image formed thereon, and transported along the transport route T toward the fixing device 13, thereby fixing the toner image onto the sheet P, under the control of the controller 100. The sheet P that has undergone the fixing process is delivered to the output tray 8, along the transport route T.

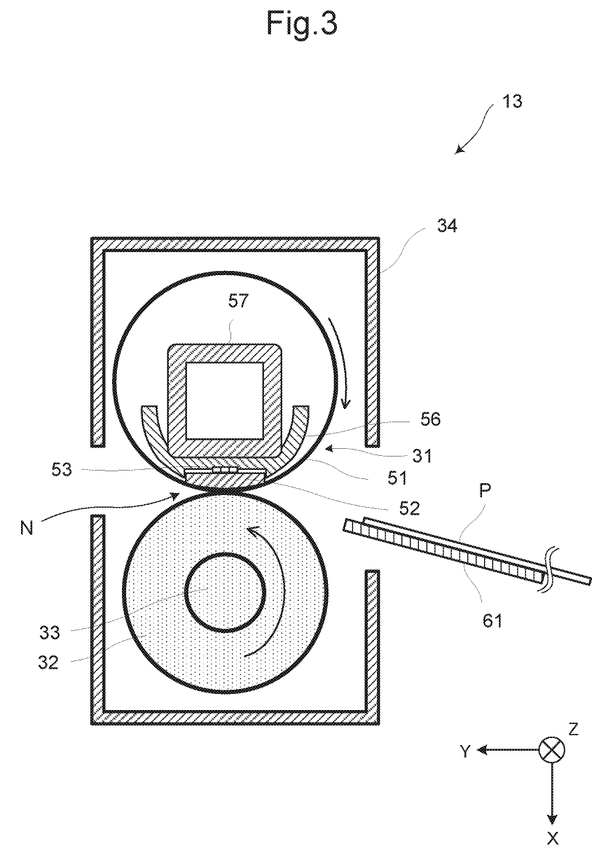

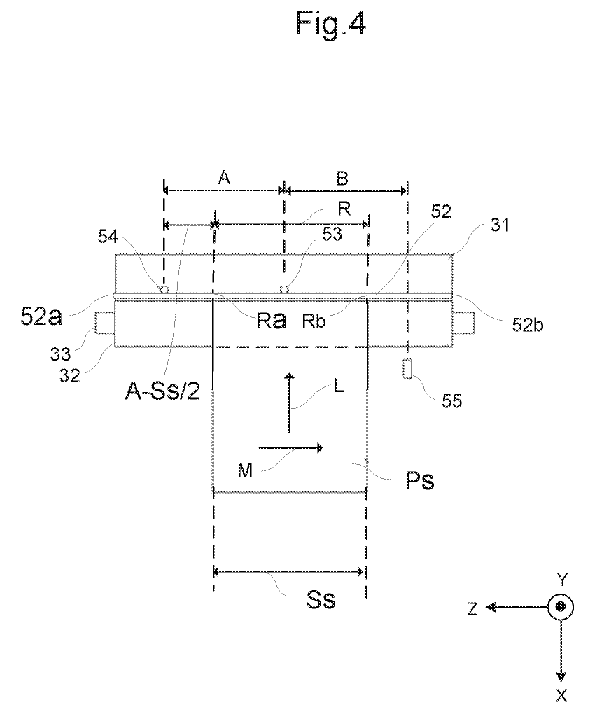

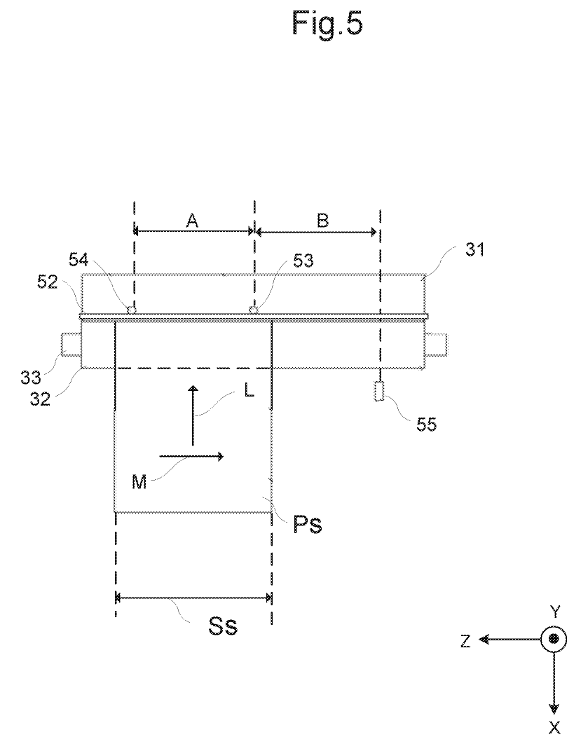

FIG. 3 is a cross-sectional view showing a configuration of the fixing device 13 shown in FIG. 1 and FIG. 2. FIG. 4 is a schematic drawing showing locations of a first temperature sensor 53, a second temperature sensor 54, and a sheet sensor 55 included in the fixing device 13 shown in FIG. 3. FIG. 5 is another schematic drawing showing locations of the first temperature sensor 53, the second temperature sensor 54, and the sheet sensor 55 included in the fixing device 13 shown in FIG. 3.

In FIG. 4 and FIG. 5, a sheet Ps represents the sheet P of the minimum size in the orthogonal direction, orthogonal to the transport direction of the sheet P toward a nip region N (direction indicated by an arrow L in FIG. 4 and FIG. 5), the orthogonal direction being a direction parallel to the face of the sheet P, in the directions orthogonal to the transport direction, as indicated by an arrow M shown in FIG. 4 and FIG. 5. Hereinafter, the size of the sheet P in the orthogonal direction defined as above will be referred to as “S” where appropriate, and the size of the minimum-sized sheet Ps in such orthogonal direction will be referred to as “Ss”, where appropriate.

The fixing device 13 includes a heat roller 31, a pressure roller 32, a housing 34, and a rotational driver 41 (see FIG. 2). The heat roller 31 and the pressure roller 32 are located inside the housing 34 made of a resin.

The pressure roller 32 includes, for example, an elastic layer formed of a silicone rubber around a core metal made of iron, and coated with a PFA resin film having a thickness of 50 μm. The pressure roller 32 is supported inside the housing 34, so as to rotate counterclockwise in FIG. 3. During the fixing operation, a rotation shaft 33 of the pressure roller 32 is driven to rotate by the rotational driver 41, for example constituted of a motor, under the control of the controller 100. The pressure roller 32 extends in the orthogonal direction (direction indicated by the arrow M in FIG. 4 and FIG. 5), orthogonal to the transport direction of the sheet P by the transport device 17 (direction indicated by the arrow L in FIG. 4 and FIG. 5), opposite the heat roller 31 (heating cylinder 51 provided on the heat roller 31), so as to define the nip region N through which the sheet P to undergo the fixing process is to pass, between the pressure roller 32 and the heat roller 31 (heating cylinder 51 provided on the heat roller 31), and fixes the toner image onto the sheet P passing through the nip region N, in collaboration with the heat roller 31.

The heat roller 31 extends in the orthogonal direction (direction indicated by the arrow M in FIG. 4 and FIG. 5), orthogonal to the transport direction of the sheet P by the transport device 17 (direction indicated by the arrow L in FIG. 4 and FIG. 5), and includes the heating cylinder 51 having a cylindrical belt-like shape, a heating device 52, the first temperature sensor 53 (see FIG. 4 and FIG. 5), the second temperature sensor 54 (see FIG. 4 and FIG. 5), the sheet sensor 55 (see FIG. 4 and FIG. 5), a retainer 56, and a presser 57. The heating device 52, the first temperature sensor 53, the second temperature sensor 54, the retainer 56, and the presser 57 are located inside the heating cylinder 51, and the sheet sensor 55 is located outside the heating cylinder 51.

The heating cylinder 51 is formed by coating, with a fluorine resin, the inner and outer surfaces of a belt made of stainless steel, for example 30 mm in outer diameter and 0.03 mm in thickness. The heating cylinder 51 is supported inside the housing 34, so as to rotate clockwise in FIG. 3. The heating cylinder 51 is pressed against the pressure roller 32 by the presser 57, constituted of a pad made of a heat-resistant resin, and is made to rotate when the pressure roller 32 rotates, so as to follow the rotation thereof.

The heating device 52 is, for example, a ceramic heater extending in the orthogonal direction (direction indicated by the arrow M in FIG. 4 and FIG. 5), orthogonal to the transport direction of the sheet P by the transport device 17 (direction indicated by the arrow L in FIG. 4 and FIG. 5), inside the heat roller 31 between an end portion and the other end portion of the heat roller 31, and serves to heat the heat roller 31. To be more detailed, the heating device 52 is located inside the heating cylinder 51 so as to oppose the inner circumferential surface of the heating cylinder 51, and thus heats the inner circumferential surface thereof. The heating device 52 performs the heating operation during the fixing process, and stops the heating operation when the fixing process is finished, under the control of the controller 100.

The retainer 56 serves to retain the heating device 52. For example, the retainer 56 retains the heating device 52, by accommodating the heating device 52 in a recess having a size that fits the heating device 52.

The transport device 17 transports, as shown in FIG. 4, the sheet P of a predetermined minimum size, through a predetermined region R of the heat roller 31 and the pressure roller 32, including the center thereof in the orthogonal direction (direction indicated by the arrow M in FIG. 4), orthogonal to the transport direction of the sheet P by the transport device 17 (direction indicated by the arrow L in FIG. 4). FIG. 4 represents the case where the sheet Ps of the minimum size is being transported to the nip region N, such that the center of the sheet Ps of the minimum size in the orthogonal direction passes the center of the heat roller 31 and the pressure roller 32 in the orthogonal direction, in other words without deviating to neither sides in the orthogonal direction. In this embodiment, the region R refers to the region through which the sheet Ps of the minimum size passes as described above.

The first temperature sensor 53, for example including a thermistor, detects the temperature in the predetermined region R on the heating device 52, as a first temperature, and outputs a detection signal indicating the first temperature, to the controller 100. The first temperature sensor 53 is fitted in a groove formed in the retainer 56, so as to contact the heating device 52. In this embodiment, the first temperature sensor 53 is located at the position corresponding to the center of the heat roller 31 and the pressure roller 32, in the orthogonal direction (direction indicated by the arrow M in FIG. 4), orthogonal to the transport direction of the sheet P by the transport device 17 (direction indicated by the arrow L in FIG. 4).

The second temperature sensor 54, for example including a thermistor, detects, as a second temperature, the temperature of a portion of the heating device 52 between an end portion 52a and an end portion Ra of the predetermined region R on the side of the end portion 52a, in the orthogonal direction (direction indicated by the arrow M in FIG. 4), orthogonal to the transport direction of the sheet P by the transport device 17 (direction indicated by the arrow L in FIG. 4), and outputs a detection signal indicating the second temperature, to the controller 100. The second temperature sensor 54 is fitted in a groove formed in the retainer 56, so as to contact the heating device 52. In this embodiment, the second temperature sensor 54 is located at the position spaced by a distance A toward the end portion 52a of the heating device 52, from the center of the sheet P being transported to the nip region N without deviating, in the orthogonal direction (direction indicated by the arrow M in FIG. 4), orthogonal to the transport direction of the sheet P by the transport device 17 (direction indicated by the arrow L in FIG. 4). The second temperature sensor 54 may detect, depending on the transport status of the sheet Ps of the minimum size, to the nip region N by the transport device 17, either the second temperature of the heating device 52, at the position corresponding to the region on the heat roller 31 where the sheet Ps of the minimum size does not pass (non-passage region), as shown in FIG. 4, or the second temperature of the heating device 52, at the position corresponding to the region on the heat roller 31 where the sheet Ps of the minimum size passes (sheet passage region), as shown in FIG. 5. FIG. 5 represents the case where the sheet Ps of the minimum size is being transported to the nip region N, with the center of the sheet Ps of the minimum size in the orthogonal direction shifted toward the end portion 52a of the heating device 52, by a distance equal to or longer than “A - Ss/2” in the orthogonal direction.

The sheet sensor 55 is a reflective optical sensor, for example based on the combination of an infrared photo integrated circuit (IC) and an infrared light emitting diode (LED). The sheet sensor 55 detects the presence of the sheet P, passing the portion of the nip region N, between the other end portion 52b of the heating device 52, and the other end portion Rb of the predetermined region R on the side of the other end portion 52b, in the orthogonal direction (direction indicated by the arrow M in FIG. 4), orthogonal to the transport direction of the sheet P by the transport device 17 (direction indicated by the arrow L in FIG. 4), and outputs a detection signal indicating the detection result, to the controller 100. In this embodiment, the sheet sensor 55 is located at the position spaced by a distance B toward the other end portion 52b of the heating device 52, from the center of the sheet P being transported to the nip region N without deviating, in the orthogonal direction (direction indicated by the arrow M in FIG. 4), orthogonal to the transport direction of the sheet P by the transport device 17 (direction indicated by the arrow L in FIG. 4).

The fixing device 13 further includes a transport guide plate 61. The transport guide plate 61, for example having a flat plate shape, serves to guide the sheet P, proceeding toward the fixing device 13 from the transport route T, to the nip region N, and is slightly spaced from the pressure roller 32, in the transport direction of the sheet P. The sheet P reaches the nip region N of the fixing device 13, by being guided by the transport guide plate 61.

In the fixing device 13 configured as above, for example when the sheet P having a size C, smaller than A + B, in the orthogonal direction orthogonal to the transport direction of the sheet P by the transport device 17 (hereinafter, “sheet Pab” where appropriate) is transported to the nip region N, with a deviation equal to or larger than “A - C/2” toward the end portion 52a of the heating device 52 in the orthogonal direction, the second temperature sensor 54 detects the second temperature of the portion of the heating device 52 corresponding to the region on the heat roller 31 where the sheet Pab passes (sheet passage region), and the sheet sensor 55 does not detect the sheet Pab. When the sheet Pab is transported to the nip region N, with a deviation smaller than “A - C/2” toward the end portion 52a of the heating device 52 in the orthogonal direction, the second temperature sensor 54 detects the second temperature of the portion of the heating device 52 corresponding to the region on the heat roller 31 where the sheet Pab does not pass (non-passage region).

The controller 100 controls the power supply to the heating device 52, so as to make the first temperature of the heating device 52, detected by the first temperature sensor 53, accord with a predetermined fixing temperature.

The controller 100 also starts successive transport of the sheet P to the nip region N by the transport device 17, at a predetermined first number of sheets per predetermined time.

In addition, upon deciding that a temperature difference between the first temperature of the heating device 52 detected by the first temperature sensor 53, and the second temperature of the heating device 52 detected by the second temperature sensor 54, is smaller than a predetermined first threshold of the temperature difference, and that the sheet sensor 55 has not detected the sheet P, the controller 100 changes the number of sheets per predetermined time, of the successive transport of the sheet P to the nip region N by the transport device 17, from the first number of sheets to a predetermined second number of sheets, fewer than the first number of sheets. When the number of sheets per predetermined time of the successive transport of the sheet P to the nip region N is changed to the second number of sheets fewer than the first number of sheets, the heat amount removed by the sheet P having the toner image formed thereon per the predetermined time is reduced, the power supply to the heating device 52, necessary for maintaining the first temperature of the heating device 52 at the fixing temperature, is also reduced. As result, an increase in temperature can be suppressed, in the portion of the heating device 52 corresponding to the region on the heat roller 31 where the sheet P does not pass (non-passage region).

The controller 100 maintains the number of sheets per predetermined time, of the successive transport of the sheet P to the nip region N by the transport device 17, at the first number of sheets, upon deciding that the temperature difference is smaller than the first threshold of the temperature difference, and that the sheet sensor 55 has detected the sheet P.

Upon deciding that the temperature difference has reached a value equal to or larger than a predetermined second threshold of the temperature difference, larger than the first threshold of the temperature difference, the controller 100 changes the number of sheets per predetermined time, of the successive transport of the sheet P to the nip region N by the transport device 17, from the first number of sheets to a predetermined third number of sheets, fewer than the first number of sheets, irrespective of the detection result of the sheet P provided by the sheet sensor 55.

Further, when the number of sheets P, successively transported to the nip region N by the transport device 17, has reached a value equal to or larger than a predetermined threshold of the number of sheets, the controller 100 decides whether the temperature difference is smaller than the first threshold of the temperature difference, and whether the sheet sensor 55 has detected the sheet P. The threshold of the number of sheets corresponds to the number of sheets that, when the successive transport of the sheet P to the nip region N by the transport device 17 is performed at the number of sheets per the predetermined time, allows the temperature of the portion of the heating device 52, corresponding to the mentioned position of the nip region N, where the sheet sensor 55 detects the presence of the sheet P, to be maintained at a predetermined permissible temperature (e.g., a temperature range between 320°C and 350°C, both ends inclusive), which is determined through experiments or simulation performed in advance.

When causing the transport device 17 to transport the sheet P at the second number of sheets, the controller 100 extends the interval between the sheets P to be successively transported to a predetermined second interval, longer than a predetermined first interval applied to the successive transport at the first number of sheets.

Hereunder, the controlling operation performed by the controller 100 with respect to the fixing device 13 will be described. The controller 100 drives the heating device 52 through a proportional-integral-differential control (PID), for example such that the first temperature of the heating device 52, detected by the first temperature sensor 53, accords with the fixing temperature. The fixing temperature is, for example, set in a temperature range between 230°C and 270°C, both ends inclusive. The controller 100 supplies the power to the heating device 52, and reduces the power supply when the first temperature of the heating device 52 detected by the first temperature sensor 53 exceeds the fixing temperature. Thereafter, when the first temperature drops to a level below the fixing temperature, the controller 100 increases the power supply to the heating device 52. Thus, the controller 100 controls the power supply to the heating device 52, such that the first temperature accords with the fixing temperature.

FIG. 6 is a flowchart showing a productivity control process, performed by the controller 100 shown in FIG. 2. FIG. 7 is a flowchart showing the productivity control process subsequent to the process of FIG. 6, performed by the controller shown in FIG. 2. The control device 10 acts as the controller 100 that performs the productivity control process shown in FIG. 6 and FIG. 7, by executing the productivity control program installed in the storage device 18.

The controller 100 starts the successive transport of the sheet P to the nip region N by the transport device 17, at the predetermined first number of sheets per predetermined time (step S1). The sheet feeding device 14 and the transport device 17 respectively drive, under the control of the controller 100, the sheet feeding motor and the transport motor, on the basis of the first number of sheets per the predetermined time, to transport the first number of sheets P per the predetermined time, to the nip region N.

After step S1, the controller 100 decides whether the printing operation has finished (step S2). Upon deciding at step S2 that the printing operation has finished (YES at S2), the controller 100 finishes the productivity control process.

Upon deciding at step S2 that the printing operation has not finished (NO at S2), the controller 100 decides whether the temperature difference between the first temperature of the heating device 52 detected by the first temperature sensor 53, and the second temperature of the heating device 52 detected by the second temperature sensor 54, is equal to or larger than the second threshold of the temperature difference (step S3). The second threshold of the temperature difference is, for example, set in a temperature range between 40°C and 50°C, both ends inclusive.

Upon deciding at step S3 that the temperature difference is equal to or larger than the second threshold of the temperature difference (YES at S3), the controller 100 changes the number of sheets per predetermined time, of the successive transport of the sheet P to the nip region N by the transport device 17, to the predetermined third number of sheets fewer than the first number of sheets (step S4). The sheet feeding device 14 and the transport device 17 respectively drive, under the control of the controller 100, the sheet feeding motor and the transport motor, on the basis of the third number of sheets per the predetermined time, to transport the third number of sheets P per the predetermined time, to the nip region N. For example, the distance between the sheets P to be successively transported, corresponding to the first number of sheets per the predetermined time, is extended to the distance between the sheets P corresponding to the third number of sheets per the predetermined time predetermined.

After step S4, the controller 100 decides whether the printing operation has finished (step S5). Upon deciding at step S2 that the printing operation has finished (YES at S5), the controller 100 finishes the productivity control process.

Upon deciding at step S5 that the printing operation has not finished (NO at S5), the controller 100 decides whether the temperature difference between the first temperature of the heating device 52 detected by the first temperature sensor 53, and the second temperature of the heating device 52 detected by the second temperature sensor 54, is smaller than the third predetermined threshold of the temperature difference, smaller than the second threshold of the temperature difference (step S6). The third threshold of the temperature difference is, for example, set in a temperature range between 10°C and 15°C, both ends inclusive. Upon deciding at step S5 that the temperature difference is not smaller than the third threshold of the temperature difference (i.e., equal to or larger than the third threshold of the temperature difference) (NO at S6), the controller 100 returns to step S5.

Upon deciding at step S6 that the temperature difference is smaller than the third threshold of the temperature difference (YES at S6), the controller 100 changes the number of sheets per predetermined time, of the successive transport of the sheet P to the nip region N by the transport device 17, to the first number of sheets (step S7). The sheet feeding device 14 and the transport device 17 respectively drive, under the control of the controller 100, the sheet feeding motor and the transport motor, on the basis of the first number of sheets per the predetermined time, to transport the first number of sheets P per the predetermined time, to the nip region N. After step S7, the controller 100 returns to step S2.

Upon deciding at step S3 that the temperature difference is not equal to or larger than the second threshold of the temperature difference (i.e., smaller than the second threshold of the temperature difference) (NO at S3), the controller 100 decides whether the number of sheets P that have been successively transported to the nip region N after the printing operation started (hereinafter, “number of successively transported sheets” where appropriate) is larger than a threshold of the number of sheets (step S8). Upon deciding at step S8 that the number of successively transported sheets is not equal to or larger than the threshold of the number of sheets (i.e., fewer than the threshold of the number of sheets) (NO at S8), the controller 100 returns to step S2.

Upon deciding at step S8 that the number of successively transported sheets is equal to or larger than the threshold of the number of sheets (YES at S8), the controller 100 decides whether the temperature difference between the first temperature of the heating device 52 detected by the first temperature sensor 53, and the second temperature of the heating device 52 detected by the second temperature sensor 54, is smaller than the first threshold of the temperature difference (step S9). The first threshold of the temperature difference is, for example, set in a temperature range between 10°C and 15°C, both ends inclusive. Upon deciding at step S9 that the temperature difference is not smaller than the first threshold of the temperature difference (i.e., equal to or larger than the first threshold of the temperature difference) (NO at S9), the controller 100 returns to step S2.

Upon deciding at step S9 that the temperature difference is smaller than the first threshold of the temperature difference (YES at S9), the controller 100 detects whether the sheet sensor 55 has detected the sheet P passing through the nip region N (step S10).

Upon deciding at step S10 that the sheet sensor 55 has detected the sheet P (YES at S10), the controller 100 maintains the number of sheets per predetermined time, of the successive transport of the sheet P to the nip region N by the transport device 17, at the first number of sheets (step S11), and returns to step S2.

Upon deciding at step S10 that the sheet sensor 55 has not detected the sheet P (NO at S10), the controller 100 changes the number of sheets per predetermined time, of the successive transport of the sheet P to the nip region N by the transport device 17, to the predetermined second number of sheets, fewer than the first number of sheets (step S12). The sheet feeding device 14 and the transport device 17 respectively drive, under the control of the controller 100, the sheet feeding motor and the transport motor, on the basis of the second number of sheets per the predetermined time, to transport the second number of sheets P per the predetermined time, to the nip region N. For example, the distance between the sheets P to be successively transported, corresponding to the second number of sheets per the predetermined time, is increased from the distance between the sheets P to be successively transported, corresponding to the first number of sheets per the predetermined time predetermined. Here, the third number of sheets of step S4 and the second number of sheets of step S12 may be the same as, or different from, each other.

After step S12, the controller 100 decides whether the printing operation has finished (step S13). Upon deciding at step S13 that the printing operation has not finished (NO at S13), the controller 100 returns to step S13. In contrast, upon deciding at step S13 that the printing operation has finished (YES at S13), the controller 100 finishes the productivity control process.

When the sheet P is transported to the nip region N, being shifted to the side of the end portion 52a of the heating device 52, in the orthogonal direction orthogonal to the transport direction of the sheet P to the nip region N, there may arise the case where, although the sheet P passes the portion of the nip region N corresponding to the temperature detection point of the second temperature sensor 54, on the heating device 52, the sheet P does not pass the sheet detection point of the sheet sensor 55. In the case where the successive transport of the sheet P to the nip region N by the transport device 17 is continued under such situation, at the predetermined first number of sheets per the predetermined time, the temperature of the portion of the heating device 52, corresponding to the region on the heat roller 31 where the sheet P does not pass (non-passage region) may excessively increase.

Under the mentioned situation, the temperature difference between the first temperature of the heating device 52 detected by the first temperature sensor 53, and the second temperature of the heating device 52 detected by the second temperature sensor 54, is smaller than the first threshold of the temperature difference, and the sheet sensor 55 does not detect the sheet P.

However, even under the mentioned situation, the temperature of the portion of the heating device 52, corresponding to the region on the heat roller 31 where the sheet P does not pass (non-passage region) does not excessively increase, until the number of sheets P successively transported to the nip region N, after the printing operation started, exceeds the threshold of the number of sheets.

According to this embodiment, when the temperature difference between the first temperature of the heating device 52 detected by the first temperature sensor 53, and the second temperature of the heating device 52 detected by the second temperature sensor 54, is smaller than the first threshold of the temperature difference, and the sheet sensor 55 does not detect the sheet P, under the situation where the number of sheets P successively transported to the nip region N has exceeded the threshold of the number of sheets, the number of sheets per predetermined time, of the successive transport of the sheet P to the nip region N by the transport device 17, is changed to the predetermined second number of sheets, fewer than the predetermined first number of sheets. Therefore, the productivity of the printing operation by the image forming apparatus 1 can be prevented from being degraded, until the number of sheets P successively transported to the nip region N exceeds the threshold of the number of sheets and, after the number of sheets P successively transported to the nip region N has exceeded the threshold of the number of sheets, the temperature of the portion of the heating device 52, corresponding to the region on the heat roller 31 where the sheet P does not pass (non-passage region) can be prevented from excessively increasing.

In addition, when the temperature difference is smaller than the first threshold of the temperature difference, and the sheet sensor 55 is detecting the sheet P, under the situation where the number of sheets P successively transported to the nip region N has exceeded the threshold of the number of sheets, the productivity of the printing operation by the image forming apparatus 1 can be prevented from being degraded, by maintaining the number of sheets per predetermined time, of the successive transport of the sheet P to the nip region N by the transport device 17, at the first number of sheets.

Further, changing the number of sheets per predetermined time, of the successive transport of the sheet P to the nip region N by the transport device 17, to the predetermined third number of sheets fewer than the first number of sheets, when the temperature difference reaches a value equal to or larger than the predetermined second threshold of the temperature difference, the temperature of the portion of the heating device 52, corresponding to the region on the heat roller 31 where the sheet P does not pass (non-passage region) can be prevented from excessively increasing.

Whereas the existing fixing devices include temperature sensors provided at the respective end portions, to perform a control for reducing the PPM on the basis of the temperature detected by those temperature sensors, it is desirable to prevent an excessive increase in temperature of the portion of the heating device, corresponding to the non-passage region on the heat roller, with a minimal number of temperature sensors. In particular, when a small-sized recording medium is transported to the nip region, with deviation in the orthogonal direction orthogonal to the transport direction of the recording medium toward the nip region, it is highly important to prevent the excessive increase in temperature of the portion of the heating device, corresponding to the non-passage region on the heat roller, with a minimal number of temperature sensors.

The configuration according to the disclosure prevents the temperature of the portion of the heating device, corresponding to the non-passage region on the heat roller, from excessively increasing, with a minimal number of temperature sensors, despite the recording medium being transported to the nip region, with deviation in the orthogonal direction orthogonal to the transport direction of the recording medium toward the nip region.

The disclosure may be modified in various manners, without limitation to the configuration according to the foregoing embodiment. Further, the configurations and processings described in the embodiments with reference to FIG. 1 to FIG. 7 are merely exemplary, and in no way intended to limit the disclosure to those configurations and processings.

While the present disclosure has been described in detail with reference to the embodiments thereof, it would be apparent to those skilled in the art that the various changes and modifications may be made therein within the scope defined by the appended claims.

What is claimed is:

1. An image forming apparatus comprising:
a fixing device;
a control device including a processor, and configured to act as a controller, when the processor executes a control program; and a transport device that transports a recording medium to the fixing device,
wherein the fixing device includes:
a heat roller extending in an orthogonal direction, orthogonal to a direction in which the transport device transports the recording medium;
a pressure roller extending in the orthogonal direction opposite the heat roller, and defining, in collaboration with the heat roller, a nip region through which the recording medium to undergo a fixing process is to pass; and
a heating device that heats the heat roller, the heating device being located inside the heat roller so as to extend in the orthogonal direction from an end portion of the heat roller to the other end portion thereof,
the transport device transports the recording medium of a predetermined minimum size, through a predetermined region of the heat roller and the pressure roller, including a central portion of the heat roller and the pressure roller in the orthogonal direction,
the fixing device further includes:
a first temperature sensor that detects, as a first temperature, a temperature of the predetermined region in the heating device;
a second temperature sensor that detects, as a second temperature, a temperature of a portion of the heating device between one end portion thereof in the orthogonal direction, and an end portion of the predetermined region on a side of the one end portion of the heating device; and
a sheet sensor that detects presence of the recording medium passing through the nip region, the sheet sensor being located at a position in the nip region corresponding to a portion of the heating device between the other end portion thereof in the orthogonal direction, and the other end portion of the predetermined region on a side of the other end portion of the heating device, and
the controller is configured to:
control power supply to the heating device, to set the first temperature to a prespecified fixing temperature;
start successive transport of the recording medium to the nip region by the transport device, at a predetermined first number of sheets per predetermined time; and
change, upon deciding that a temperature difference between the first temperature and the second temperature is smaller than a predetermined first threshold of the temperature difference, and that the sheet sensor has not detected the recording medium, the number of sheets per predetermined time, of the successive transport of the recording medium to the nip region by the transport device, from the first number of sheets to a predetermined second number of sheets, fewer than the first number of sheets.

2. The image forming apparatus according to claim 1,
wherein, upon deciding that the temperature difference is smaller than the first threshold of the temperature difference, and that the sheet sensor has detected the recording medium, the controller maintains the number of sheets per predetermined time, of the successive transport of the recording medium to the nip region by the transport device, at the first number of sheets.

3. The image forming apparatus according to claim 1,
wherein the controller decides, when the number of sheets of the recording medium successively transported to the nip region by the transport device reaches a value equal to or larger than a predetermined threshold of the number of sheets, whether the temperature difference is smaller than the first threshold of the temperature difference, and whether the sheet sensor has detected the recording medium, and
the threshold of the number of sheets corresponds to the number of sheets that, when the successive transport of the recording medium to the nip region by the transport device is performed at the first number of sheets per the predetermined time, allows the temperature of the portion of the heating device, corresponding to the position on the nip region, where the sheet sensor detects the presence of the recording medium, to be maintained at a predetermined permissible temperature.

4. The image forming apparatus according to claim 1,
wherein, upon deciding that the temperature difference has reached a value equal to or larger than a predetermined second threshold of the temperature
difference, larger than the first threshold of the temperature difference, the controller changes the number of sheets per predetermined time, of the successive transport of the recording medium to the nip region by the transport device, to a predetermined third number of sheets fewer than the first number of sheets, irrespective of whether the sheet sensor has detected the presence of the recording medium.

5. The image forming apparatus according to claim 1,
wherein, when causing the transport device to successively transport the recording medium at the second number of sheets, the controller sets an interval between the recording media to be successively transported, to a predetermined second interval longer than a predetermined first interval, applied when the recording medium is transported at the first number of sheets.

6. The image forming apparatus according to claim 4 ,
wherein the second number of sheets and the third number of sheets are equal to each other.

7. The image forming apparatus according to claim 1,
wherein the heat roller includes a heating cylinder having a cylindrical belt-like shape, and
the heating device is located on an inner side of the heating cylinder, and heats an inner circumferential surface of the heating cylinder.
